(19) United States
(12) Patent Application Publication
(10) Pub. No.: US 2012/0250829 A1
(43) Pub. Date: Oct. 4, 2012

(54) DEVICE FOR TESTING FUNCTION OF TELEPHONE EXCHANGE

(75) Inventors: CHIEN-CHIH WU, NEW TAIPEI CITY (TW); CHING-FENG HSIEH, TAIPEI CITY (TW)

(73) Assignee: ASKEY COMPUTER CORP.

(21) Appl. No.: 13/165,817

(22) Filed: Jun. 22, 2011

(30) Foreign Application Priority Data
Apr. 1, 2011 (TW) 100111543

(51) Int. Cl. H04M 3/22

(52) U.S. Cl. 379/26.01

(57) ABSTRACT

A device for testing a function of a telephone exchange during a production process includes a sending-end module for sending a test criterion, a receiving-end module for receiving a test criterion, an input/output interface module connected to a telephone exchange, a call connection indicating unit, a signal switching unit, and a controlling unit for controlling a test procedure. The device not only tests whether a call can be connected and whether a call can be answered, but analyzes local electrical characteristics of the telephone exchange at the telephone exchange-end. With the device, signals treated by an analog-to-digital conversion process can display various voice information of a voice signal conveyed by the telephone exchange, such that a damaged portion of the telephone exchange can be assessed whenever a test fails, thereby cutting test costs and production costs.

### CROSS-REFERENCE TO RELATED APPLICATION

This non-provisional application claims priority under 35 U.S.C. §119(a) on Patent Application No(s).100111543 filed in Taiwan, R.O.C. on Apr. 1, 2011, the entire contents of which are hereby incorporated by reference.

### FIELD OF TECHNOLOGY

The present invention relates to automatic test devices, and more particularly, to a device for testing a call connection function of a telephone exchange during a production process.

### BACKGROUND

A call connection function test has to be conducted during a manufacturing process of some telecommunication products which include a conventional telephone exchange, an online telephone exchange, and even an optical network terminal (ONT), a cable modem, and a DSL modem which have an online telephone exchange function.

In this regard, a conventional test entails: connecting two telephone set interfaces of a telephone exchange to two telephone sets, respectively; calling first said telephone set from second said telephone set manually; and determining a call connection function of the telephone exchange according to whether first said telephone set rings or not and whether the call can be answered. However, the conventional test is predisposed to mistakes of manual operation and human-induced errors in criteria of judgment.

Another conventional test entails: connecting two modems which are connected to a computer to two telephone set interfaces of the telephone exchange, respectively; and determining a call connection function of the telephone exchange by the computer controlling the modems in outputting and receiving a signal. However, to effectuate collaborative operation, the conventional test requires two additional modems which occupy much space on a production line, make it impossible to perform a test on plenty of products simultaneously, and fail to obtain sufficient test data.

Yet another conventional test entails obtaining a complete test result by a precise apparatus. Although the test result thus obtained is relatively complete, the precise apparatus is expensive and thus only applicable to a test conducted in a R&D stage or a design stage rather than a test conducted on a production line.

### SUMMARY

It is an objective of the present invention to provide a device that meets the need to perform a test on a production line quickly and accurately.

Another objective of the present invention is to provide a device that can be automatically operated such that a plurality of telephone exchanges can be tested by the devices concurrently.

Yet another objective of the present invention is to provide a device for providing a call connection function, evaluating local electrical characteristics, and testing the quality of a voice signal.

In order to achieve the above and other objectives, the present invention provides a device for testing a function of a telephone exchange. The device comprises: a sending-end module for generating and sending a voice signal and a dialing signal to the telephone exchange; a receiving-end module for testing electrical characteristics of the voice signal sent from the telephone exchange after being transmitted inside the telephone exchange, and for converting the voice signal sent from the telephone exchange into a digital signal; an input/output interface module comprising a telephone set interface unit and comprising a first interface and a second interface which are electrically connected to two telephone set interfaces of the telephone exchange, respectively; a call connection indicating unit electrically connected to the telephone set interface unit for generating an indicating signal in response to a status of electrical connection between the first interface and the second interface; a signal switching unit electrically connected to the sending-end module, the receiving-end module, and the telephone set interface unit and adapted to switch a transmission path of the voice signal; and a controlling unit electrically connected to the sending-end module, the receiving-end module, the call connection indicating unit, and the signal switching unit and adapted to controllably drive the sending-end module and the signal switching unit to send the dialing signal to the telephone exchange via the first interface. After receiving the dialing signal, the telephone exchange generates a ring signal. The ring signal enters the call connection indicating unit via the input/output interface module and produces a first test result according to whether the indicating signal has been generated.

In an embodiment, under the control of the controlling unit, the signal switching unit receives a local voltage current signal from a telephone set interface of the telephone exchange through the second interface in response to generation of the indicating signal and sends the local voltage current signal to the receiving-end module such that electrical characteristics of the local voltage current signal are treated as a second test result.

In an embodiment, under the control of the controlling unit, the sending-end module generates the voice signal, and the voice signal sent out from the telephone exchange and received via the second interface is sent to the receiving-end module through the signal switching unit, such that the voice signal converted into a digital signal by the receiving-end module is treated as a third test result.

In an embodiment, the sending-end module further comprises: a dialing unit controlled by the controlling unit and adapted to generate the dialing signal for performing a dialing operation; and a voice generating unit controlled by the controlling unit and adapted to generate the voice signal.

In an embodiment, the receiving-end module further comprises: a voice signal amplifying unit electrically connected to the signal switching unit and adapted to amplify the voice signal sent out from the telephone exchange; a current/voltage testing unit electrically connected to the signal switching unit and adapted to test a current/voltage level of the voice signal and a local current/voltage level of the local voltage current signal; and an analog-to-digital conversion unit electrically connected to the voice signal amplifying unit and the current/voltage testing unit and adapted to convert the voice signal thus amplified, the current/voltage level of the voice signal, and the local current/voltage level of the local voltage current signal into a digital signal and send the digital signal to the controlling unit.

In an embodiment, the controlling unit compares the voice signal which has been converted into the digital signal and a preset audio standard data and treats a comparison result as the third test result.

The device of the present invention not only tests whether a call can be connected and whether a call can be answered, but analyzes electrical characteristics of an interface of the telephone exchange. With the device, signals treated by an analog-to-digital conversion process can display various voice information of a voice signal conveyed by the telephone exchange, and all the test results are quantified and conveyed to a back-end computer, such that a damaged portion of the telephone exchange can be assessed at the manufacturer end whenever a test fails, thereby cutting test costs, testing time, and production costs.

### BRIEF DESCRIPTION OF THE DRAWINGS

Objectives, features, and advantages of the present invention are hereunder illustrated with specific embodiments in conjunction with the accompanying drawings, in which:

FIG. 1 is a function block diagram of a device for testing a telephone exchange according to an embodiment of the present invention; and

FIG. 2 is a function block diagram of a device for testing a telephone exchange according to another embodiment of the present invention.

### DETAILED DESCRIPTION

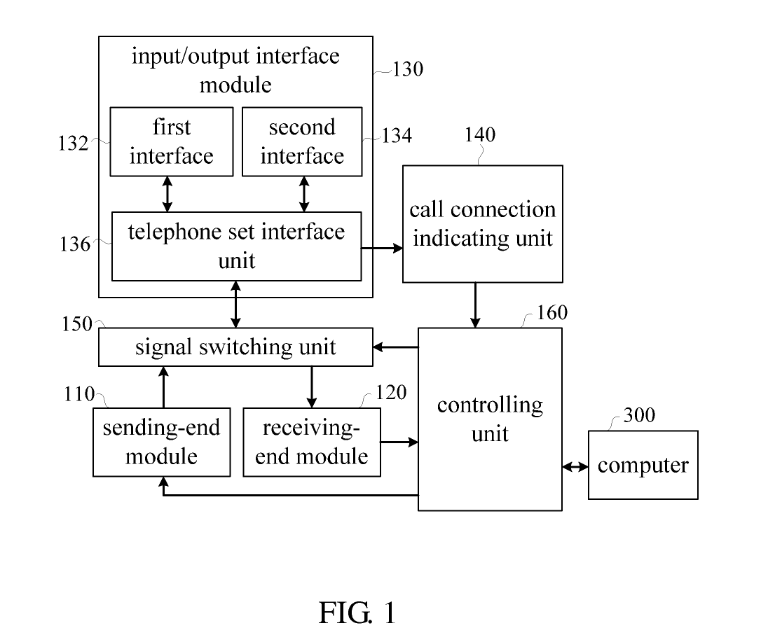

Referring to FIG. 1, there is shown a function block diagram of a device for testing a telephone exchange according to an embodiment of the present invention. The device comprises a sending-end module 110, a receiving-end module 120, an input/output interface module 130, a call connection indicating unit 140, a signal switching unit 150, and a controlling unit 160.

The sending-end module 110 is controlled by the controlling unit 160 and is for use in generating a dialing signal and a voice signal. The dialing signal is for triggering a telephone exchange, that is, triggering a call connection function of a product under test, such that the telephone exchange is in a call-connected status. Afterward, the telephone exchange generates a call connection ring signal and sends the ring signal to the call connection indicating unit 140 via the input/output interface module 130. The voice signal is for determining the quality of the voice transmission of the telephone exchange That is, after the voice signal has been delivered within the telephone exchange, it is feasible to determine whether the strength, the signal frequency shift, and the signal to noise level of the voice signal sent from the telephone exchange meet the related standards. With the device according to an embodiment of the present invention, the aforesaid are quantified and provided to a back-end computer 300 for determination.

The receiving-end module 120 is for testing the electrical characteristics of the voice signal sent from the telephone exchange so as to determine the electrical characteristics of the voice signal sent from a local end of the telephone exchange, and is for amplifying the voice signal so as to determine the quality of the voice signal, such as the strength of the voice signal. The receiving-end module 120 also converts the determined electrical characteristics and the amplified voice signal into a digital signal, such that the digital signal drives the back-end computer 300 to record data.

In an embodiment of the present invention, the device simulates a sending end and a receiving end, and thus the input/output interface module 130 comprises a first interface 132 as a first telephone set and a second interface 134 as a second telephone set. Hence, the interfaces 132, 134 can be electrically connected to the two telephone set interfaces of the telephone exchange, respectively. The input/output interface module 130 comprises a telephone set interface unit 136 which is electrically connected to the interfaces and used for serving as a bridge interface for signal transmission.

The call connection indicating unit 140 is electrically connected to the telephone set interface unit 136 in response to whether the dialing signal generated by the sending-end module 110 has successfully triggered the telephone exchange. After receiving the dialing signal, the telephone exchange generates the ring signal. The ring signal enters the call connection indicating unit 140 via the input/output interface module 130. The call connection indicating unit 140 converts the ring signal into an indicating signal. That is, the first interface 132 and the second interface 134 will be electrically connected, provided that the call connection function of the telephone exchange is good. Hence, the ring signal generated by the telephone exchange enables the call connection indicating unit 140. For example, the indicating signal is equivalent to a ring at the receiving end.

The signal switching unit 150 is controlled by the controlling unit 160 and is electrically connected to the sending-end module 110, the receiving-end module 120, and the telephone set interface unit 136 for switching a transmission path of the voice signal. That is, the signal switching unit 150 controlled by the controlling unit 160 distinguishes the test signal sending function from the test signal receiving function of the device, such that the transmission of signals can be correctly processed.

The controlling unit 160 is the core of the control of the test procedure carried out by the device according to an embodiment of the present invention. The controlling unit 160 is electrically connected to the sending-end module 110, the receiving-end module 120, the call connection indicating unit 140, and the signal switching unit 150. Under the control of the controlling unit 160, the sending-end module 110 sends the dialing signal to the telephone exchange through the first interface 132 of the input/output interface module 130 to produce a first test result according to whether the indicating signal has been generated. Under the control of the controlling unit 160, the signal switching unit 150 receives the local voltage current signal from a telephone set interface of the telephone exchange through the second interface 134 in response to the generation of the indicating signal and sends the local voltage current signal to the receiving-end module 120 such that the electrical characteristics of the local voltage current signal are treated as a second test result.

The controlling unit 160 can further control the sending-end module 110 in sending out the voice signal through the signal switching unit 150 which has undergone a switching process once again and the first interface 132 in response to the generation of the electrical characteristics of the voice signal. Afterward, the second interface 134 receives the voice signal from the telephone exchange. Then, the voice signal is sent to the receiving-end module 120 through the signal switching unit 150 which has undergone a switching process once again, converted into the digital signal, and treated as a third test result.

Afterward, the test results are sent to the computer 300. The controlling unit 160 treats the voice signal which has been amplified and converted into the digital signal as the third test result and sends it to the computer 300. Alternatively, the controlling unit 160 compares the voice signal which has been amplified and converted into the digital signal and a preset audio standard data, treats the comparison result as the third test result, and sends the third test result to the computer 300.

Accordingly, the process flow of a test conducted by means of the device according to an embodiment of the present invention is described hereunder.

Under the control of the controlling unit 160, the sending-end module 110 generates the dialing signal for performing a dialing operation and sends the dialing signal thus generated to the telephone exchange.

Once the telephone exchange successfully receives the dialing signal, that is, when the call gets connected, it will mean that the call connection function of the telephone exchange (i.e., the device under test) is good. As a result, the call connection indicating unit 140 receives the ring signal from the telephone exchange The call connection indicating unit 140 converts the ring signal into the indicating signal (a first test result) and informs the controlling unit 160 of the aforesaid signal conversion. Afterward, under the control of the controlling unit 160, the receiving-end module 120 answers the call; or, in other words, under the control of the controlling unit 160, the signal switching unit 150 causes the local voltage current signal to be transmitted from a telephone set interface of the telephone exchange to the receiving-end module 120.

The receiving-end module 120 processes the local voltage current signal to identify electrical characteristics (a second test result) thereof, digitalizes the electrical characteristics thus identified, and sends the second test result to an internal memory of the controlling unit 160 or an external memory (not shown).

Then, under the control of the controlling unit 160, the sending-end module 110 generates the voice signal to simulate the course of a call, and the voice signal is sent to an interface of the telephone exchange. Afterward, the telephone exchange sends out the voice signal via another interface; and then, under the control of the controlling unit 160, the voice signal is sent to the receiving-end module 120 and processed therein to yield a third test result.

Eventually, the first, second, and third test results are sent to the computer 300. The test results are going to be analyzed by the computer 300 later. However, the controlling unit 160 can also perform the aforesaid analysis in part or even in whole. This embodiment is just illustrative of the present invention. Persons skilled in the art can readily conceive different aspects of the implementation of data analysis of the present invention without being limited by the disclosure of this embodiment.

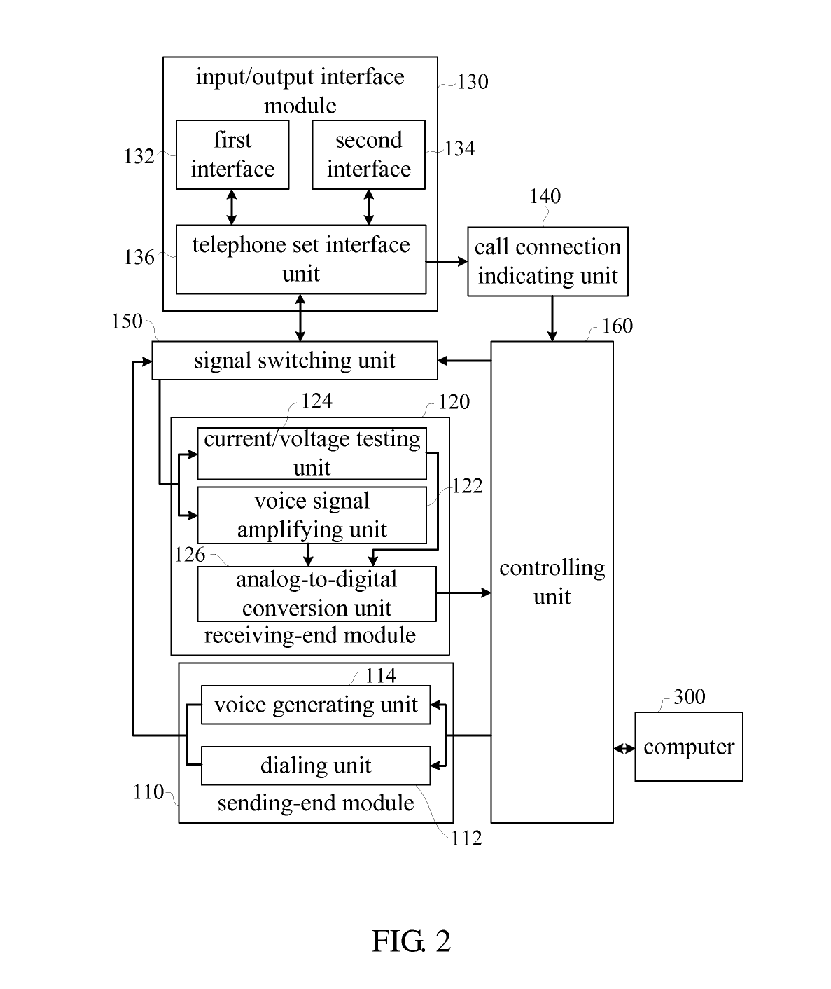

Referring to FIG. 2, there is shown a function block diagram of a device for testing the telephone exchange according to another embodiment of the present invention. The sending-end module 110 further comprises a dialing unit 112 and a voice generating unit 114. The dialing unit 112 is electrically connected to the signal switching unit 150. The dialing unit 112 is placed under the control of the controlling unit 160 and adapted to generate the dialing signal for performing a dialing operation. The voice generating unit 114 is electrically connected to the signal switching unit 150 and is also placed under the control of the controlling unit 160 to generate the voice signal. For example, an audio information can be stored in the voice generating unit 114 in advance, such that the stored audio information can be selected by the controlling unit 160 whenever the voice signal is to be generated.

The receiving-end module 120 further comprises a voice signal amplifying unit 122, a current/voltage testing unit 124, and an analog-to-digital conversion unit 126. The voice signal amplifying unit 122 is electrically connected to the signal switching unit 150 and adapted to amplify the voice signal. The current/voltage testing unit 124 is electrically connected to the signal switching unit 150 and adapted to measure the voice signal current/voltage level and a local current/voltage level at a telephone set interface of the telephone exchange, so as to obtain the local electrical characteristics of the telephone exchange. The analog-to-digital conversion unit 126 is electrically connected to the voice signal amplifying unit 122, the current/voltage testing unit 124, and the controlling unit 160 and adapted to convert the amplified voice signal and the current/voltage level of the voice signal into a digital signal for being transmitted to the controlling unit 160.

In conclusion, in an embodiment of the present invention, the device quantifies all the test items and sends the quantified data to the computer 300. The test results indicate whether the test items are up to standard or not. Upon detection of a non-conforming telephone exchange, the manufacturer end of the non-conforming telephone exchange can determine, by making reference to the test results, whether the problem lies in an audio amplifying circuit, an audio encoding/decoding circuit, or an interface local current/voltage generating circuit of the non-conforming telephone exchange, so as to reduce the time taken to perform maintenance, thereby cutting test costs and production costs.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A device for testing a function of a telephone exchange, the device comprising:
a sending-end module for generating and sending a voice signal and a dialing signal to the telephone exchange;
a receiving-end module for testing electrical characteristics of the voice signal sent from the telephone exchange after being transmitted inside the telephone exchange, and for converting the voice signal sent from the telephone exchange into a digital signal;
an input/output interface module comprising a telephone set interface unit and comprising a first interface and a second interface which are electrically connected to two telephone set interfaces of the telephone exchange, respectively;
a call connection indicating unit electrically connected to the telephone set interface unit for generating an indicating signal in response to a status of electrical connection between the first interface and the second interface;
a signal switching unit electrically connected to the sending-end module, the receiving-end module, and the telephone set interface unit and used for switching a transmission path of the voice signal; and
a controlling unit electrically connected to the sending-end module, the receiving-end module, the call connection indicating unit, and the signal switching unit and used for controlling the sending-end module and the signal switching unit to send the dialing signal to the telephone exchange via the first interface and producing a first test result according to whether the indicating signal has been generated.

2. The device of claim 1, wherein the controlling unit controls the signal switching unit in receiving a local voltage current signal from a telephone set interface of the telephone exchange through the second interface in response to generation of the indicating signal and sending the local voltage current signal to the receiving-end module such that electrical characteristics of the local voltage current signal are treated as a second test result.

3. The device of claim 2, wherein the controlling unit controls the sending-end module in generating the voice signal and sending the voice signal sent out from the telephone exchange and received via the second interface to the receiving-end module, such that the voice signal converted into a digital signal by the receiving-end module is treated as a third test result.

4. The device of claim 3, wherein the sending-end module further comprises:
a dialing unit controlled by the controlling unit and used for generating the dialing signal for performing a dialing operation; and
a voice generating unit controlled by the controlling unit and used for generating the voice signal.

5. The device of claim 3, wherein the receiving-end module further comprises:
a voice signal amplifying unit electrically connected to the signal switching unit and used for amplifying the voice signal sent out from the telephone exchange;
a current/voltage testing unit electrically connected to the signal switching unit and used for testing a current/voltage level of the voice signal and a local current/voltage level of the local voltage current signal; and
an analog-to-digital conversion unit electrically connected to the voice signal amplifying unit and the current/voltage testing unit and used for converting the voice signal amplified, the current/voltage level of the voice signal, and the local current/voltage level of the local voltage current signal into a digital signal and sending the digital signal to the controlling unit.

6. The device of claim 3, wherein the controlling unit compares the voice signal which has been converted into the digital signal and a preset audio standard data and treats a comparison result as the third test result.
